(19) United States
(12) Patent Application Publication
(10) Pub. No.: US 2015/0098658 A1
(43) Pub. Date: Apr. 9, 2015

(54) METHOD AND APPARATUS FOR PROCESSING IMAGE DATA, AND RECORDING MEDIUM

(71) Applicant: SAMSUNG ELECTRONICS CO., LTD., Suwon-si (KR)

(72) Inventors: Yong-min TAI, Yongin-si (KR); Young-su MOON, Seoul (KR); Jong-hun LEE, Suwon-si (KR); Jung-uk CHO, Hwaseong-si (KR); Do-hyung KIM, Hwaseong-si (KR); Si-hwa LEE, Seoul (KR)

(73) Assignee: SAMSUNG ELECTRONICS CO., LTD., Suwon-si (KR)

(21) Appl. No.: 14/507,324

(22) Filed: Oct. 6, 2014

(30) Foreign Application Priority Data
Oct. 4, 2013 (KR) 10-2013-0118727

(51) Int. Cl. G06T 7/00; G06K 9/46

(52) U.S. Cl. CPC G06T 7/0085; G06K 9/4604
USPC 382/199

(57) ABSTRACT

A method of processing image data includes a plurality of different processes performed based on edge information generated as a result of performing a preset process from among the plurality of different processes. Therefore, the time for processing the image data is reduced, and image quality is enhanced.

### RELATED APPLICATIONS

This application claims the benefit of Korean Patent Application No. 10-2013-0118727, filed on Oct. 4, 2013, in the Korean Intellectual Property Office, the disclosure of which is incorporated herein in its entirety by reference.

### BACKGROUND

1. Field

The present disclosure relates to methods and apparatuses for processing image data, and a recording medium.

2. Description of the Related Art

In general, a digital image apparatus converts an optical signal into a digitized electric signal and displays the digitized electric signal on a display apparatus. The optical signal is, for example, an analog signal that an image photographing apparatus generates through a lens and a sensor.

A plurality of image processing processes for processing image data are performed to display the electric signal on the display apparatus. Although sharable image information exists between the plurality of image processing processes, image data is separately processed without sharing the image information in the related art.

Therefore, in the related art, a process of processing the image data is repeated, and thus, a speed of processing the image data is reduced.

### SUMMARY

Provided are methods and apparatuses for processing image data by sharing edge information between different processes.

Additional aspects will be set forth in part in the description which follows and, in part, will be apparent from the description, or may be learned by practice of the presented embodiments.

According to an aspect of the present invention, a method of processing image data includes: acquiring image data; performing a first process of a plurality of different processes for processing the image data on the acquired image data; storing first edge information generated as a result of performing the first process; and performing, based on the stored first edge information, a second process on an image generated as a result of performing the first process.

The method may further include: performing, based on edge information used in the previous process, a current process on an image generated as a result of performing a previous process of the plurality of different processes.

The performing of the second process may include extracting the stored first edge information.

The plurality of different processes may include a noise reduction process, a detail enhancement process, and a demosacing process.

The storing of the first edge information may include: determining whether each of a plurality of pixels constituting the acquired image data is an edge; and storing the determination result.

The storing of the first edge information may include storing, based on the determination result, position information of one of the plurality of pixels determined as an edge.

The second process may be performed, based on the determination result, on pixels determined as edges.

The performing of the second process may include, if second edge information generated as a result of performing the second process is different from the first edge information, updating the stored first edge information as the second edge information.

If an edge determination reference value set to generate the first edge information in the first process is smaller than an edge determination reference value set in the second process, the first edge information may be updated as the second edge information generated as the result of performing the second process.

The method may further include: performing post-processing on the color image based on the color image and final edge information for changing at least one of brightness and color of a color image generated as a result of performing the plurality of different processes

According to another aspect of the present invention, an apparatus for processing image data includes: an input unit which acquires image data; and a controller which performs on the acquired image data a first process of a plurality of different processes for processing the image data, controls a memory to store first edge information generated as a result of performing the first process, and performs a second process based on the stored first edge information on an image generated as a result of performing the first process.

### BRIEF DESCRIPTION OF THE DRAWINGS

These and/or other aspects will become apparent and more readily appreciated from the following description of the embodiments, taken in conjunction with the accompanying drawings in which:

FIG. 1 a view illustrating a system for processing image data according to an embodiment of the present invention;

FIG. 2 is a flowchart illustrating a method of processing image data according to an embodiment of the present invention;

FIG. 3 is a flowchart illustrating a method of sharing edge information between different processes to process image data according to an embodiment of the present invention;

FIG. 4 is a flowchart illustrating a method of updating edge information between different processes according to an embodiment of the present invention;

FIG. 5 is a block diagram of an apparatus for processing image data according to an embodiment of the present invention; and

FIG. 6 is a detailed block diagram illustrating an image processing apparatus according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

When an element is referred to as being “connected to” or “coupled to” another element, it may be directly connected or coupled to the other element or intervening elements may be present. It will be further understood that the terms “comprises,” “comprising,” “includes,” and/or “including,” when used herein, specify the presence of stated elements and/or components, but do not preclude the presence or addition of one or more other elements and/or components.

The present invention will now be described more fully with reference to the accompanying drawings.

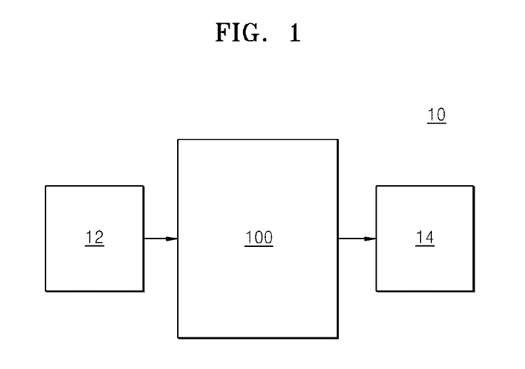

FIG. 1 is a view illustrating a system 10 for processing image data according to an embodiment of the present invention.

The system 10 of FIG. 1 includes only elements that are related to the present embodiment. Therefore, the system 100 may include other general-purpose elements besides the elements of FIG. 1.

Referring to FIG. 1, the system 10 includes an image photographing apparatus 12, an image data processing apparatus 100, and a display apparatus 14.

The image photographing apparatus 12 may include a semiconductor device that generates light corresponding to a subject as an electric signal. The image photographing apparatus 12 may include a charge-coupled device (CCD) sensor or a complementary metal-oxide semiconductor (CMOS) sensor.

The image data processing apparatus 100 may acquire raw data corresponding to the electric signal that is generated by the image photographing apparatus 12 and digitized. The image data processing apparatus 100 may perform at least one image processing process on the acquired raw data to generate a color image. An image processing process may include a process of reducing noise, a process of enhancing a light amount reduction phenomenon of an image caused by a lens, a process of correcting color temperature information, etc.

The image data processing apparatus 100 may include at least one or more function blocks that perform different processes, to perform various image processing processes. The various image processing processes performed by the image data processing apparatus 100 may include processes that are performed based on edge information of image data. For example, the processes that are performed based on the edge information of the image data may include a noise reduction process, a detail enhancement process, and a demosacing process.

If different first and second processes are performed based on edge information, a general image data processing apparatus does not perform the second process based on edge information that is generated as a result of performing the first process. In other words, the general image data processing apparatus does not share edge information between a plurality of different processes that use edge information. Therefore, if edge information generated as a result of performing the first process exists, the general image data processing apparatus newly generates edge information in the second process.

The image data processing apparatus 100 according to the present embodiment may share edge information between a plurality of different processes. Therefore, if the image data processing apparatus 100 performs another process based on the edge information after performing a preset process that generates edge information, the image data processing apparatus 100 may use the edge information that is generated as a result of the performing the preset process. If pre-generated edge information is used without re-generating edge information between different processes, the efficiency of processing image data may be enhanced.

The display apparatus 14 may display the color image output by the image data processing apparatus 100. The display apparatus 14 may also include a function of displaying an image and a function of performing various types of post-processing on the color image. For example, if the display apparatus 14 is a smart phone, the display apparatus 14 may increase a contrast of a color of an image captured through a photographing application or may perform post-processing, such as adjusting of an intensity of light, or the like, on the color image.

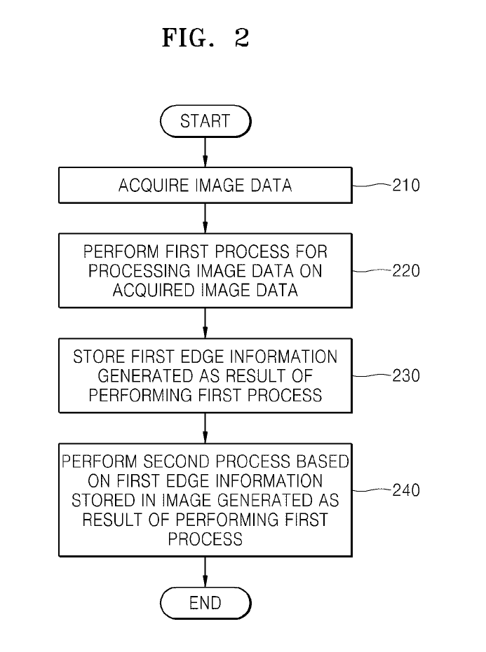

FIG. 2 is a flowchart illustrating a method of processing image data according to an embodiment of the present invention.

Referring to FIG. 2, in operation 210, the image data processing apparatus 100 acquires image data. The image data may be an electric signal that is generated in response to light bouncing off a subject.

The image data processing apparatus 100 according to the present embodiment may acquire the image data from an external device that includes a CCD sensor or a CMOS sensor. According to another embodiment, the image data processing apparatus 100 may acquire the image data from a camera module that includes a CCD sensor or a CMOS sensor.

In operation 220, the image data processing apparatus 100 may perform a first process of a plurality of different processes for processing image data, on the acquired image data. The first process may be one of image processing processes that are performed based on edge information of the image data.

The image processing processes that are performed on the edge information of the image data may include a detail enhancement process of correcting an error that crumbles an edge portion, by using the edge information of the image data. The image processing processes that are performed based on the edge information may also include a demosacing process of correcting one kind of color information existing in one pixel as three full colors.

However, a plurality of difference processes are not limited to a noise reduction process, a detail enhancement process, and a demosacing process. All image processing processes that are performed by generating edge information from image data may be included in a plurality of different processes.

In operation 230, the image data processing apparatus 100 stores first edge information that is generated as a result of performing the first process. The image data processing apparatus 100 may determine a method of storing the first edge information based on a memory size that is secured to store the first edge information.

For example, if the memory size is small, the image data processing apparatus 100 may include only information about whether a preset pixel of a plurality of pixels included as the first edge information in the image data is included in an edge. The image data processing apparatus 100 may also store only position information of a pixel determined as an edge according to the memory size, as the first edge information.

According to another embodiment, the image data processing apparatus 100 may store information about a probability that a preset pixel will be included in an edge, as the first edge information. If a result value acquired by applying an edge information detection algorithm to the preset pixel is larger than a preset threshold value, the first process may detect the preset pixel as the edge. The preset threshold value may vary with each edge information detection algorithm. The image data processing apparatus 100 may determine a probability that the preset pixel will be the edge, according to a degree of the result value larger than the preset threshold value.

According to another embodiment, the first edge information may include information about an accuracy of the edge information detection algorithm used in the first process. Various types of edge information detection algorithms may be used in a plurality of different image processing processes, and accuracies of the edge information detection algorithms respectively necessary in the plurality of different image processing processes may be different from one another.

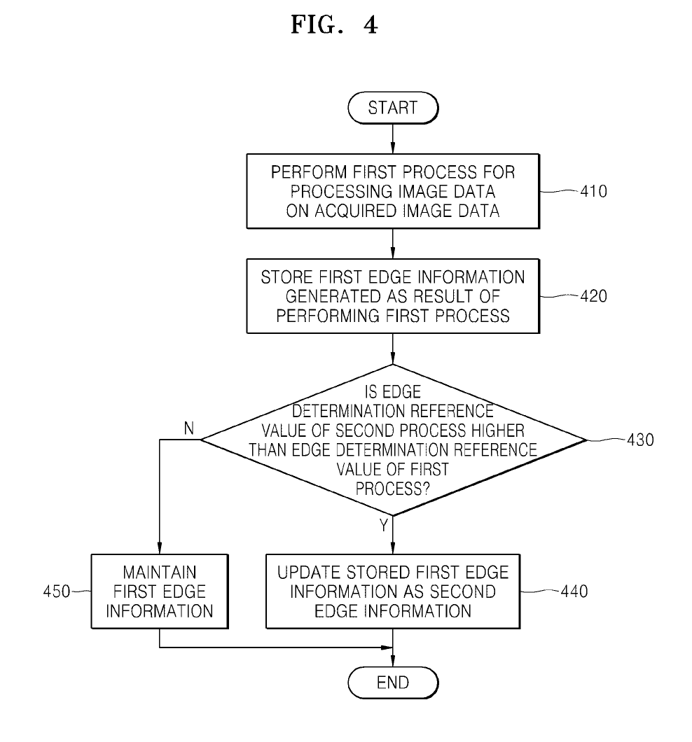

If the first edge information includes information about the accuracy of the edge information detection algorithm, and an accuracy of an edge information detection algorithm of a current process is lowered more than that of an edge information detection algorithm of a previous process, edge information generated in the previous process may be used without generating edge information in the current process. A speed and efficiency of an image processing process may be increased through the above-described process. This will be described in more detail later with reference to FIG. 4.

In operation 240, the image data processing apparatus 100 performs a second process based on the first edge information stored in an image generated as a result of performing the first process.

The image data processing apparatus 100 may extract the stored first edge information. The image data processing apparatus 100 may distinguish an edge area determined in the first process from pixels included in the image data based on the extracted first edge information.

According to an embodiment of the present invention, the image data processing apparatus 100 may perform the second process only on a pixel distinguished as an edge area in the first process. The image data processing apparatus 100 may perform the second process based on the first edge information acquired in the first process to reduce a time taken for processing the image data.

According to another embodiment of the present invention, the image data processing apparatus 100 may apply the edge information detection algorithm of the second process to a pixel positioned within a preset range from the pixel distinguished as the edge area in the first process. For example, if the accuracy of the edge information detection algorithm of the first process is low, the edge information detection algorithm of the second process may be additionally used with respect to a pixel adjacent to a pixel determined as an edge area in the second process.

According to another embodiment of the present invention, the first edge information may include information about a probability that a preset pixel will be included in an edge. In this case, the image data processing apparatus 100 may use different algorithms with respect to a pixel having a probability higher than or equal to a preset value or a pixel having a probability lower than the preset value to perform the second process. The higher probability means that the pixel will be included in an edge, and the lower probability means that the pixel will be included in the edge.

For example, if the second process is a noise reduction process, a bilateral filter may be applied with respect to a pixel of a plurality of pixels included in the image data to calculate a pixel value. A probability that the pixel will be included in an edge is higher than or equal to a preset value. A pixel value of a pixel of the plurality of pixels may be calculated with an average of pixel values of neighboring pixels, wherein a probability that the pixel will be included in the edge is lower than the preset value. The bilateral filter has a higher accuracy than an operation of calculating the average of the pixel values of the neighboring pixels, but a calculation process of the bilateral filter is very complicated. Therefore, the bilateral filter may be applied only with respect to a pixel having a high probability that the pixel will be included in an edge in order to enhance efficiency and accuracy of processing image data.

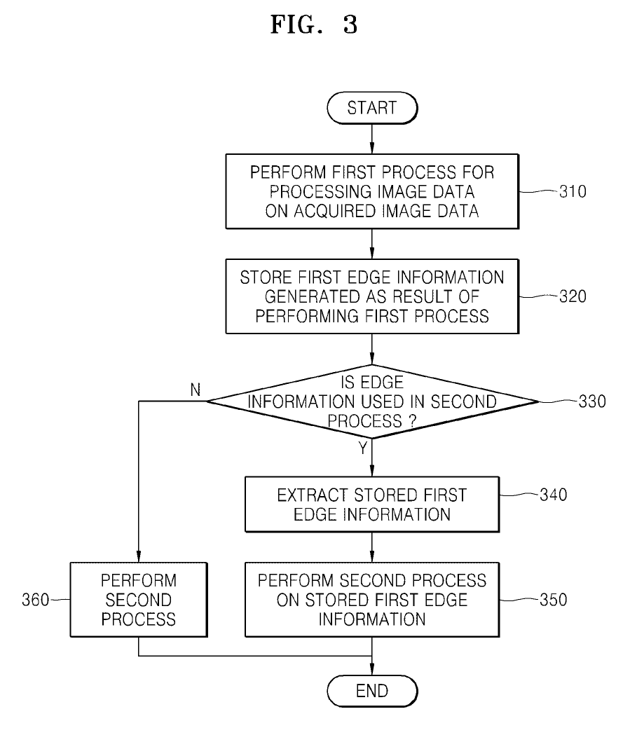

FIG. 3 is a flowchart illustrating a method of sharing edge information between different processes to process image data according to an embodiment of the present invention.

In operation 310, the image data processing apparatus 100 performs a first process of different processes for processing image data on acquired image data. The first process may be one of image processing processes that are performed based on edge information of the image data.

In operation 320, the image data processing apparatus 100 stores first edge information that is generated as a result of performing the first process. The image data processing apparatus 100 may store the first edge information in various types of memories. For example, the image data processing apparatus 100 may include only information about whether a preset pixel of a plurality of pixels included in the image data is included in an edge, as the first edge information. The image data processing apparatus 100 may store position information of a pixel determined as an edge according to a memory size, as the first edge information.

According to another embodiment, the image data processing apparatus 100 may store information about a probability that the preset pixel will be included in the edge as the first edge information. According to another embodiment, the first edge information may include information about an accuracy of an edge information detection algorithm used in the first process.

In operation 330, the image data processing apparatus 100 determines whether a second process is a process that uses edge information. Processes that do not use edge information may be included in an image processing processes that are performable by the image data processing apparatus 100. Therefore, the image data processing apparatus 100 may determine whether the second process is the process that uses the edge information in order to determine whether to extract the stored first edge information.

Image processing processes that do not use edge information may include a defect pixel correction process, a white balance process, a wide dynamic range process, etc.

In operation 340, the image data processing apparatus 100 extracts the stored first edge information. If the second process is an image processing process that is performed based on edge information, the image data processing apparatus 100 may extract the first edge information that is stored in a memory.

In operation 350, the image data processing apparatus 100 performs the second process based on the extracted first edge information. According to an embodiment of the present invention, the image data processing apparatus 100 may perform the second process only on a pixel that is distinguished as an edge area in the first process. According to another embodiment of the present invention, the image data processing apparatus 100 may apply an edge information detection algorithm of the second process to a pixel that is positioned within a preset range from the pixel determined as the edge area in the first process. According to another embodiment of the present invention, the image data processing apparatus 100 may apply different algorithms with respect to a pixel having a probability higher than or equal to a preset value and a pixel having a probability lower than the preset value, to perform the second process. The higher probability means that the pixel will be included in an edge, and the lower probability means that the pixel will be included in the edge.

In operation 360, the image data processing apparatus 100 performs the second process. If the second process is not the image processing process that is performed based on the edge information, the image data processing apparatus 100 may perform the second process without extracting the first edge information stored in the memory.

FIG. 4 is a flowchart illustrating a method of updating edge information between different processes according to an embodiment of the present invention.

In operation 410, the image data processing apparatus 100 performs a first process of different processes for processing image data on acquired image data. The first process may be one of image processing processes that are performed based on edge information of the image data.

In operation 420, the image data processing apparatus 100 stores first edge information that is generated as a result of performing the first process. The image data processing apparatus 100 may include as the first edge information only information about whether a preset pixel of a plurality of pixels included in the image data is included in an edge. The image data processing apparatus 100 may store as the first edge information only position information of a pixel determined as an edge according to a memory size.

According to another embodiment, the image data processing apparatus 100 may store as the first edge information information about a probability that the preset pixel will be included in the edge. According to another embodiment, the first edge information may include information about an accuracy of an edge information detection algorithm used in the first process.

In operation 430, the image data processing apparatus 100 determines whether an edge determination reference value of a second process is higher than an edge determination reference value of the first process. The edge determination reference value may be an indicator that indicates an accuracy of an edge information detection algorithm applied to each process. The accuracy may be a value that is preset based on an actual operation result of each edge information detection algorithm.

For example, the first process may be a noise removal process, and the second process may be a demosacing process. An algorithm used in a demosacing process in a general image processing process may more accurately detect an edge than an algorithm used in the first process. In this case, the edge determination reference value of the second process may be higher than the edge determination reference value of the first process.

To compare edge determination reference values between different processes, an accuracy of an algorithm of each process is digitized and preset in edge information. For example, an edge determination reference value of a noise removal algorithm may be set to 5, an edge determination reference value of a demosacing algorithm may be set to 8, and the set edge determination reference values may be stored in edge information of each process.

In operation 440, the image data processing apparatus 100 updates the stored first edge information as second edge information. If the edge determination reference value of the second process is higher than the edge determination reference value of the first process, the image data processing apparatus 100 may determine that an edge detection of an algorithm of the second process is more accurate than an edge detection of an algorithm of the first process. In this case, the image data processing apparatus 100 may update the first edge information stored in a memory as the second edge information.

In operation 450, the image data processing apparatus 100 maintains the first edge information. If the edge determination reference value of the second process is lower than the edge determination reference value of the first process, the image data processing apparatus 100 may determine that the edge detection of the algorithm of the first process is more accurate than the edge detection of the algorithm of the second process. In this case, the image data processing apparatus 100 may not update the first edge information as the second edge information.

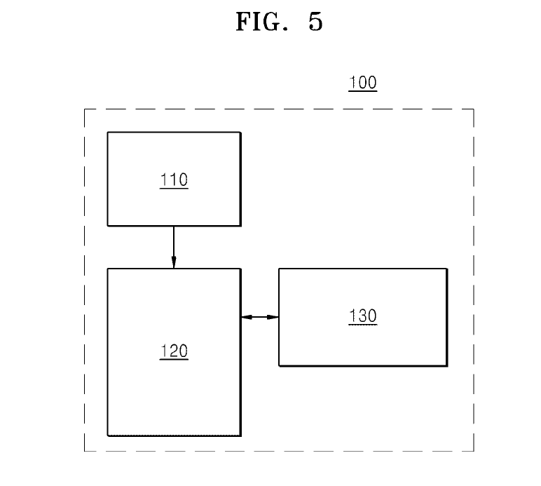

FIG. 5 is a block diagram of the image data processing apparatus 100, according to an embodiment of the present invention.

The image data processing apparatus 100 of FIG. 5 includes only elements that are related to the present embodiment. Therefore, the image data processing apparatus 100 may further include other general-purpose elements besides the elements of FIG. 5.

Referring to FIG. 5, the image data processing apparatus 100 includes an input unit 110, a controller 120, and a memory 130.

The input unit 110 may acquire image data. The image data may include raw data corresponding to an electric signal that is generated by the image photographing apparatus 12 of FIG. 1 and is then digitized. The image photographing apparatus 12 may be included as a CMOS sensor or a CCD sensor in the image data processing apparatus 100.

The controller 120 may perform a first process of a plurality of different processes for processing image data on the acquired image data. The different processes may include a noise reduction process, a detail enhancement process, and a demosacing process, and the controller 120 may generate first edge information as a result of performing the first process. The controller 120 according to the present embodiment may control the memory 130 to store the generated first edge information in the memory.

The controller 120 may perform, based on the first edge information, a second process on an image that is generated as a result of performing the first process on the acquired image data. The controller 120 may extract the first edge information from the memory 130 to perform the second process.

The controller 120 may perform, based on edge information generated as a result of performing the previous process, a current process on an image generated as a result of performing a previous process of the plurality of different processes.

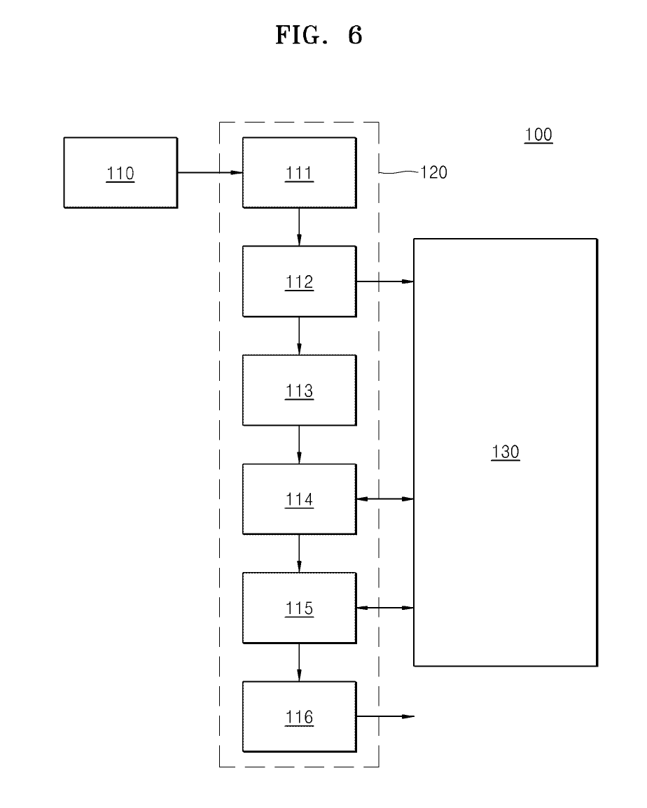

FIG. 6 is a detailed block diagram illustrating the image data processing apparatus 100, according to an embodiment of the present invention 100.

The image data processing apparatus 100 of FIG. 6 includes only elements that are related to the present embodiment. Therefore, the image data processing apparatus 100 may further include other general-purpose elements besides the elements of FIG. 6.

Referring to FIG. 6, the image data processing apparatus 100 includes the input unit 110, the controller 120, and the memory 130. The controller 120 includes a defect pixel correction process performer 121, a noise removal process performer 122, a white balance process performer 123, a detail enhancement process performer 124, a demosacing process performer 125, and a wide dynamic range process performer 126. The input unit 110 may acquire image data. The image data may include raw data corresponding to an electric signal that is generated by the image photographing apparatus 12 and is then digitized. The image photographing apparatus 12 may be included as a CMOS sensor or a CCD sensor in the image data processing apparatus 100.

The controller 120 may include at least one of the process performers 121, 122, 123, 124, 125, and 126 to perform at least one image processing process on the acquired image data.

The defect pixel correction process performer 121 may correct an error of a pixel value of the image data that occurs due to a defect of an image photographing apparatus (for example, a CCD sensor or a CMOS sensor), wherein the image data is acquired by the input unit 110. A defect pixel correction process is an image processing process that does not use edge information of image data. Therefore, the defect pixel correction process performer 121 may not generate edge information of the acquired image data.

The noise removal process performer 122 may distinguish an edge portion from and image to perform a noise removal process of softly removing noise from the edge portion. The noise removal process distinguishes the edge portion of the image from an image and thus is an image processing process that uses edge information. Therefore, the noise removal process performer 122 may perform the noise removal process on the image data to generate first edge information. The first edge information generated by the noise removal process performer 122 may be stored in the memory 130.

According to an embodiment of the present invention, information about whether a preset pixel of a plurality of pixels included in the image data is included in an edge may be included as the first edge information. The first edge information may include position information of a pixel determined as an edge.

According to another embodiment, the first edge information may include information about a probability that the preset pixel will be included in the edge. The first edge information may include information about an accuracy of an edge information detection algorithm applied to the first process.

The white balance process performer 123 may perform a white balance process of correcting a color temperature of the image data. The white balance process is an image processing process that does not use the edge information of the image data. Therefore, the white balance process performer 123 may not extract the edge information from the memory 130.

The detail enhancement process performer 124 may extract the edge information from the image data to correct an error that crumbles the edge portion. A detail enhancement process is an image processing process that uses the edge information of the image data. Therefore, the detail enhancement process performer 124 may extract the stored first edge information from the memory 130 to use the first edge information.

The detail enhancement process performer 124 may perform, based on the first edge information, the detail enhancement process only on an area determined as an edge. According to another embodiment, the detail enhancement process performer 124 may perform, based on the first edge information, the detail enhancement process on an area determined as an edge and a neighboring area. The detail enhancement process performer 124 may transmit second edge information generated as a result of performing the detail enhancement process to the memory 130 based on the first edge information.

The demosacing process performer 125 may perform a demosacing process of forming one kind of color information of one pixel as a full color (for example, RGB). The demosacing process may generate by using the edge information an image that is not deteriorated when forming a full color image. In other words, the demosacing process is an image processing process that uses the edge information of the image data. Therefore, the demosacing process performer 125 may extract the stored second edge information from the memory 130 to perform the demosacing process based on the extracted second edge information.

Based on the second edge information, the demosacing process performer 125 may perform the demosacing process only on the area determined as the edge. According to another embodiment, the demosacing process performer 125 may perform, based on the second edge information, the demosacing process on the area determined as the edge and a neighboring area. The demosacing process performer 125 may transmit third edge information generated as a result of performing the demosacing process to the memory 130 based on the second edge information.

The wide dynamic range process performer 126 may perform a wide dynamic range process of adjusting brightness of the image data. The wide dynamic range process is an image processing process that does not use the edge information of the image data. Therefore, the wide dynamic range process performer 126 may not extract the edge information from the memory 130.

A plurality of different processes may be performed in the controller 120 to finally acquire a color image. According to an embodiment of the present invention, the image data processing apparatus 10 may perform post-processing for changing at least one of color and brightness of the color image on the color image based on the color image and the third edge information stored in the memory 130.

An apparatus according to the present invention may include a processor, a memory that stores and executes program data, a permanent storage such as a disk drive, a communication port that communicates with an external apparatus, a user interface such as a touch panel, a key, a button, or the like, etc. Methods of embodying a software module or an algorithm may be stored as computer-readable codes or program commands executable on the processor, on a computer-readable recording medium. Examples of the computer-readable recording medium include a magnetic storage medium (for example, read-only memory (ROM), random-access memory (RAM), a floppy disc, a hard disk, etc.) and an optical reading medium (for example, CD-ROMs, digital versatile discs (DVDs), etc.). The computer-readable recording medium may also be distributed over network coupled computer systems so that the computer-readable code is stored and executed in a distributed fashion. The computer-readable recording medium may be read by a computer, stored in a memory, and executed by a processor.

All types of documents including published documents, patent applications, patents, etc. cited in the present invention may be integrated herein like cited documents are separately and detailedly integrated or are entirely integrated herein.

For understanding of the present invention, reference numerals are shown in the embodiments illustrated in the drawings, and particular terminologies are used to describe the embodiments. However, the present invention is not limited by the particular terminologies, and the present invention may include all types of elements that may be considered by those of ordinary skill in the art.

The present invention may be embodied as functional block structures and various processing operations. These functional blocks may be embodied via various numbers of hardware and/or software structures that execute particular functions. For example, the present invention may use direct circuit structures, such as a memory, processing, logic, a look-up table, etc. that may execute various functions through controls of one or more microprocessors or other control apparatuses. Like elements of the present invention may be executed as software programming or software elements, the present invention may be embodied as a programming or scripting language such as C, C++, assembly language, or the like, including various algorithms that are realized through combinations of data structures, processes, routines, or other programming structures. Functional sides may be embodied as an algorithm that is executed by one or more processors. Also, the present invention may use related arts to perform electronic environment setting, signal processing, and/or data processing, etc. Terminology such as a mechanism, an element, a means, or a structure may be widely used and is not limited as mechanical and physical structures. The terminology may also include meanings of a series of routines of software along with a processor, etc.

The particular embodiments described in the present invention are just exemplary and do not limit the scope of the present invention. For conciseness of the present specification, descriptions of the conventional electronic elements, control systems, software, and other functional sides of the systems have been omitted. Also, connections between lines of elements shown in the drawings or connection members of the lines exemplarily indicate functional connections and/or physical connections or circuit connections. The connections may be replaced or may be indicated as additional various functional connections, physical connections, or circuit connections in a real apparatus. If there is no detailed mention such as “necessary”, “important”, or the like, the connections may not be elements necessary for making the present invention.

What is claimed is:

1. A method of processing image data, the method comprising:
acquiring image data;
performing a first process of a plurality of different processes for processing the image data on the acquired image data;
storing first edge information generated as a result of performing the first process; and
performing, based on the stored first edge information, a second process on an image generated as a result of performing the first process.

2. The method of claim 1, further comprising:
performing, based on edge information used in the previous process, a current process on an image generated as a result of performing a previous process of the plurality of different processes.

3. The method of claim 1, wherein the performing of the second process comprises extracting the stored first edge information.

4. The method of claim 1, wherein the plurality of different processes comprise a noise reduction process, a detail enhancement process, and a demosacing process.

5. The method of claim 1, wherein the storing of the first edge information comprises:
determining whether each of a plurality of pixels constituting the acquired image data is an edge; and
storing the determination result.

6. The method of claim 5, wherein the storing of the first edge information comprises storing, based on the determination result, position information of one of the plurality of pixels determined as an edge.

7. The method of claim 5, wherein the second process is performed, based on the determination result, on pixels determined as edges.

8. The method of claim 1, wherein the performing of the second process comprises, if second edge information generated as a result of performing the second process is different from the first edge information, updating the stored first edge information as the second edge information.

9. The method of claim 8, wherein if an edge determination reference value set to generate the first edge information in the first process is smaller than an edge determination reference value set in the second process, the first edge information is updated as the second edge information generated as the result of performing the second process.

10. The method of claim 1, further comprising:
performing post-processing on the color image based on the color image and final edge information for changing at least one of brightness and color of a color image generated as a result of performing the plurality of different processes.

11. An apparatus for processing image data, the apparatus comprising:
an input unit which acquires image data; and
a controller which performs on the acquired image data a first process of a plurality of different processes for processing the image data, controls a memory to store first edge information generated as a result of performing the first process, and performs a second process based on the stored first edge information on an image generated as a result of performing the first process.

12. The apparatus of claim 11, wherein the controller performs, based on edge information used in the previous process, a current process on an image generated as a result of performing a previous process of the plurality of different processes.

13. The apparatus of claim 11, wherein the controller extracts the first edge information from the memory.

14. The apparatus of claim 11, wherein the plurality of different processes comprise a noise reduction process, a detail enhancement process, and a demosacing process.

15. The apparatus of claim 11, wherein the memory stores a determination result that is acquired by determining, by the controller, whether each of a plurality of pixels constituting the acquired image data is an edge.

16. The apparatus of claim 15, wherein the memory stores position information of one of the plurality of pixels determined as an edge based on the determination result.

17. The apparatus of claim 15, wherein the controller performs, based on the determination result, the second process on pixels determined as edges.

18. The apparatus of claim 11, wherein if second edge information generated as a result of performing the second process is different from the first edge information, the controller updates the stored first edge information as the second edge information.

19. The apparatus of claim 18, wherein if an edge determination reference value set to generate the first edge information in the first process is smaller than an edge determination reference value set in the second process, the controller updates the first edge information as the second edge information generated as the result of performing the second process.

20. The apparatus of claim 11, wherein the apparatus performs post-processing on the color image based on the color image and final edge information for changing at least one of brightness and color of a color image generated as a result of performing the plurality of different processes.

21. A computer-readable recording medium having recorded thereon a program for executing the method of claim 1 in a computer.
